(19) United States
(12) Patent Application Publication
(10) Pub. No.: US 2024/0029128 A1
(43) Pub. Date: Jan. 25, 2024

(54) METHOD AND SYSTEM FOR MANAGING TRADING COLLECTIBLES

(71) Applicant: Andreas Tzouvaras, Portsmouth, RI (US)

(72) Inventor: Andreas Tzouvaras, Portsmouth, RI (US)

(21) Appl. No.: 18/224,307

(22) Filed: Jul. 20, 2023

Related U.S. Application Data
(60) Provisional application No. 63/390,878, filed on Jul. 20, 2022.

(51) Int. Cl. G06Q 30/0601

(52) U.S. Cl. CPC G06Q 30/0611; G06Q 30/0641; G06Q 30/0623

(57) ABSTRACT

A system and method to manage trading of collectibles between users using an online application is disclosed. The system and method allow users to create accounts with the online application to upload collectibles for trading. The users can view collectibles owned by other users, request trades between each other for the collectibles and accept or decline trades through the online application conveniently and transparently from anywhere.

### BACKGROUND

### Technical Field

The present disclosure relates, in general, to the trading of items over the Internet. In particular, but without limitation, the present disclosure relates to a method and system for managing trading collectibles over the Internet.

Trading collectible applications are known in the art. For example, U.S. Pat. No. 6,688,973 discloses a system for using trading cards interactively through an electronic network. U.S. Pat. No. 8,635,146 discloses a sports share trading system and method. However, the current systems and methods for trading collectibles online do not provide a convenient mechanism for connecting collectible owners with one another to trade collectible collectibles easily and safely.

Accordingly, a need exists for an improved system and method for managing trading collectibles online.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### SUMMARY

A computer-implemented method to manage trading of collectibles between users over the Internet using an online application is disclosed. The method includes allowing a user to register with the online application for trading the collectibles; presenting a dashboard screen interface to allows the user to access one or more selection icons associated with trading the collectibles; allowing the user to upload one or more user owned collectibles to the online application; displaying a trade request screen interface to allow the user to view a received trade request from a requesting user on the online application; displaying a trade request sent screen interface to allow the user to view a sent trade request sent by the user to a receiving user on the online application; upon receiving a trade request, directing the user to a collectible selection screen interface to allow the user to view collectibles owned by the requesting user; allowing selection, by the user, of one or more of the collectibles owned by the requesting user for a trade between the user and the requesting user; allowing approval of the trade between the user and the requesting user or decline of the trade between the user and the requesting user; and responsive to the approval of the trade between the user and the requesting user, completing the trade between the user and the requesting user.

A system for managing trading of collectibles between users over the Internet using an online application is disclosed. The system includes at least one memory configured to store computer executable instructions; and at least one processor configured to execute the computer executable instructions to: allow a user to register with the online application for trading the collectibles; present a dashboard screen interface to allows the user to access one or more selection icons associated with trading the collectibles; allow the user to upload one or more user owned collectibles to the online application; display a trade request screen interface to allow the user to view a received trade request from a requesting user on the online application; display a trade request sent screen interface to allow the user to view a sent trade request sent by the user to a receiving user on the online application; upon receiving a trade request, direct the user to a collectible selection screen interface to allow the user to view collectibles owned by the requesting user; allow selection, by the user, of one or more of the collectible collectibles owned by the requesting user for a trade between the user and the requesting user; allow approval of the trade between the user and the requesting user or decline of the trade between the user and the requesting user; and responsive to the approval of the trade between the user and the requesting user, completing the trade between the user and the requesting user.

In an aspect of the disclosure, a computer program product comprising a non-transitory computer readable medium having stored thereon computer executable instructions, which when executed by one or more processors, cause the one or more processors to manage trading of collectibles between users over the Internet using an online application is disclosed. The operations include allowing a user to register with the online application for trading the collectibles; presenting a dashboard screen interface to allows the user to access one or more selection icons associated with trading the collectibles; allowing the user to upload one or more user owned collectibles to the online application; displaying a trade request screen interface to allow the user to view a received trade request from a requesting user on the online application; displaying a trade request sent screen interface to allow the user to view a sent trade request sent by the user to a receiving user on the online application; upon receiving a trade request, directing the user to a collectible selection screen interface to allow the user to view collectibles owned by the requesting user; allowing selection, by the user, of one or more of the collectibles owned by the requesting user for a trade between the user and the requesting user; allowing approval of the trade between the user and the requesting user or decline of the trade between the user and the requesting user; and responsive to the approval of the trade between the user and the requesting user, completing the trade between the user and the requesting user.

The foregoing summary is illustrative only and is not intended to be in any way limiting. In addition to the illustrative aspects, aspects, and features described above, further aspects, aspects, and features will become apparent by reference to the drawings and the following detailed description.

Other systems, methods, features, and advantages of the disclosure will be, or will become, apparent to one with skill in the art upon examination of the following figures and detailed description. It is intended that all such additional systems, methods, features and advantages be included within this description, be within the scope of the disclosure, and be protected by the following claims.

### BRIEF DESCRIPTION OF THE DRAWINGS

The disclosure can be better understood with reference to the following drawings and description of an aspect. The elements in the figures are not necessarily to scale, emphasis instead being placed upon illustrating the principles of an aspect of the disclosure. Moreover, in the figures, like referenced numerals designate corresponding parts throughout the different views of the aspect.

FIG. 1 is a schematic view of a registration screen, according to an aspect of the disclosure.

FIG. 2 is a schematic view of a dashboard screen, according to an aspect of the disclosure.

FIG. 3 is another schematic view of a dashboard screen, according to an aspect of the disclosure.

FIG. 4 is a schematic view of a subscribe screen, according to an aspect of the disclosure.

FIG. 5 is a schematic view of a collectibles display screen, according to an aspect of the disclosure.

FIG. 6 is a schematic view of a submit collectible screen, according to an aspect of the disclosure.

FIG. 7 is a schematic view of a trade requests received screen, according to an aspect of the disclosure.

FIG. 8 is a schematic view of a trade requests sent screen, according to an aspect of the disclosure.

FIG. 9 is a schematic view of an affiliate area screen, according to an aspect of the disclosure.

FIG. 10 is a schematic view of a user profile screen, according to an aspect of the disclosure.

FIG. 11 is a schematic view of a user login screen, according to an aspect of the disclosure.

FIG. 12 is a schematic view of a collectible search screen, according to an aspect of the disclosure.

FIG. 13 is a schematic view of a collectible detail screen, according to an aspect of the disclosure.

FIG. 14 is a schematic view of a trade requests received screen, according to an aspect of the disclosure.

FIG. 15 is a schematic view of a collectible selection screen, according to an aspect of the disclosure.

FIG. 16 is a schematic view of a trade requests received screen, according to an aspect of the disclosure.

FIG. 17 is a schematic view of a trade request accept screen, according to an aspect of the disclosure.

FIG. 18 is another schematic view of a trade requests sent screen, according to an aspect of the disclosure.

FIG. 19 is another schematic view of a trade requests received screen, according to an aspect of the disclosure.

FIG. 20 is another schematic view of a trade requests received screen, according to an aspect of the disclosure.

FIG. 21 is another schematic view of a trade requests sent screen, according to an aspect of the disclosure.

FIG. 22 is another schematic view of a trade requests received screen, according to an aspect of the disclosure.

FIG. 23 illustrates acts 2300 taken in a method for managing trading collectibles, according to an aspect of the disclosure.

FIG. 24 illustrates an example communications network employed by users that supports the disclosed system for managing trading collectibles.

### DETAILED DESCRIPTION

Some aspects of the present disclosure will now be described more fully hereinafter with reference to the accompanying drawings, in which some, but not all, aspects are shown. Indeed, various aspects may be embodied in many different forms and should not be construed as limited to the aspects set forth herein; rather, these aspects are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with aspects of the present disclosure. Thus, use of any such terms should not be taken to limit the spirit and scope of aspects of the present disclosure.

The elements in the Figures interoperate as explained in more detail below. Before setting forth the detail explanation, however, it is noted that all of the discussion below, regardless of the particular implementation being described, is exemplary in nature, rather than limiting. For example, although selected aspects and their features or processes of the implementations are depicted as being stored in memories, all or part of systems and methods consistent with the display systems may be stored on, distributed across, or read from other machine-readable media, for example, secondary storage devices such as hard disks, floppy disks, and CD-ROMs; a signal received from a network; or other forms of ROM or RAM either currently known or later developed.

Furthermore, although specific elements of the architecture of an example aspect will be described, methods, systems, and articles of manufacture consistent with the architecture may include additional or different elements. For example, a processor may be implemented as a microprocessor, microcontroller, application specific integrated circuit (ASIC), discrete logic, or a combination of other type of circuits or logic. Similarly, memories may be DRAM, SRAM, Flash, or any other type of memory. Flags, data, databases, tables, and other data structures may be separately stored and managed, may be incorporated into a single memory or database, may be distributed, or may be logically and physically organized in many different ways. Method and systems described herein may be parts of a single method and system, separate methods and systems, or distributed across several memories and processors.

In the following description, numerous specific details are set forth to clearly describe various specific aspects disclosed herein. One skilled in the art, however, will understand that the presently claimed disclosure may be practiced without all of the specific details discussed below. In other instances, well-known features have not been described so as not to obscure the disclosure. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings. In addition, it should be understood that aspects of the disclosure include both hardware and electronic components or modules that, for purposes of discussion, may be illustrated and described as if the majority of the components were implemented solely in hardware. However, one of ordinary skill in the art, and based on a reading of this detailed description, would recognize that, in at least one aspect, the electronic based aspects of the disclosure may be implemented in software. As such, it should be noted that a plurality of hardware and software-based devices, as well as a plurality of different structural components may be utilized to implement the disclosure. Furthermore, and as described in subsequent paragraphs, the specific logical software configurations illustrated in the drawings are intended to exemplify aspects of the disclosure and that other alternative configurations are possible.

Moreover, acts and steps taken in a process disclosed herein may be different or performed with more or fewer acts or steps taken to execute the process and the acts and steps illustrated herein are not necessarily in a specific order. Acts and process steps taken may be in different order as known to one of skill in the art.

The following briefly describes the aspects of the disclosure. This brief description is not intended as an extensive overview. It is not intended to identify key or critical elements, or to delineate or otherwise narrow the scope. Its purpose is merely to present some concepts in a simplified form as a prelude to the more detailed description that is presented later.

According to some aspects, a system and method for managing trading collectibles, is presently disclosed. The presently disclosed system and method may be used by people who are interested to trade the collectibles that they have with others without leaving the comfort of their homes and having a number of options while trading, i.e., lots of other people who want to trade and a number of collectibles that may not be available in the market. The presently disclosed system and method makes it convenient by allowing users to trade/exchange their collectibles remotely without the need to meet strangers to perform the trade. Examples of collectibles include, but are not limited to, sports trading cards (e.g., baseball, basketball, football, soccer, hockey, golf, etc.), game cards (Pokemon, Magic, Dungeons and Dragons, etc.), stamps, coins, figurines, commemorative event collectibles and other collectibles that may retain value as a collectible commodity.

According to some aspects, the presently disclosed system and method may be implemented using one or more servers accessible by one or more one or more visitors to a website hosted by one or more servers and store the processed actions in a database. According to some aspects, the presently disclosed system and method may be implemented using one or more computing devices such as, for example, computer(s), laptop(s), smart phone(s), and/or tablets.

According to some aspects, the presently disclosed system and method may be implemented as one or more respective software modules operating the one or more computing devices. Computing device(s) may include a processing unit, a system memory, and a system bus that couples processing unit to the various components of computer. A processing unit may include one or more processors, each of which may be in the form of any one of various commercially available processors. A system memory may include a read only memory (ROM) that stores a basic input/output system (BIOS) containing start-up routines for computer, and a random access memory (RAM). A system bus may be a memory bus, a peripheral bus or a local bus, and may be compatible with any of a variety of bus protocols, including PCI, VESA, Microchannel, ISA, and EISA. A computing device(s) may also include a hard drive, a floppy drive, and CD ROM drive that are connected to system bus by respective interfaces. Hard drives, floppy drives, and CD ROM drives contain respective computer-readable media disks that provide non-volatile or persistent storage for data, data structures and computer-executable instructions. Other computer-readable storage devices (e.g., magnetic tape drives, flash memory devices, and digital video disks) also may be used with the computing device(s). A user may interact (e.g., enter commands or data) with the computing device(s) using a keyboard and a mouse. Other input devices (e.g., a microphone, joystick, stylus or touch pad) also may be provided. Information may be displayed to the user on a monitor. Computing device(s) also may include peripheral output devices, such as speakers and a printer. One or more remote computers may be connected to the computing device(s) over a local area network (LAN), and one or more remote computers may be connected to the computing device(s) over a wide area network (WAN) (e.g., the Internet).

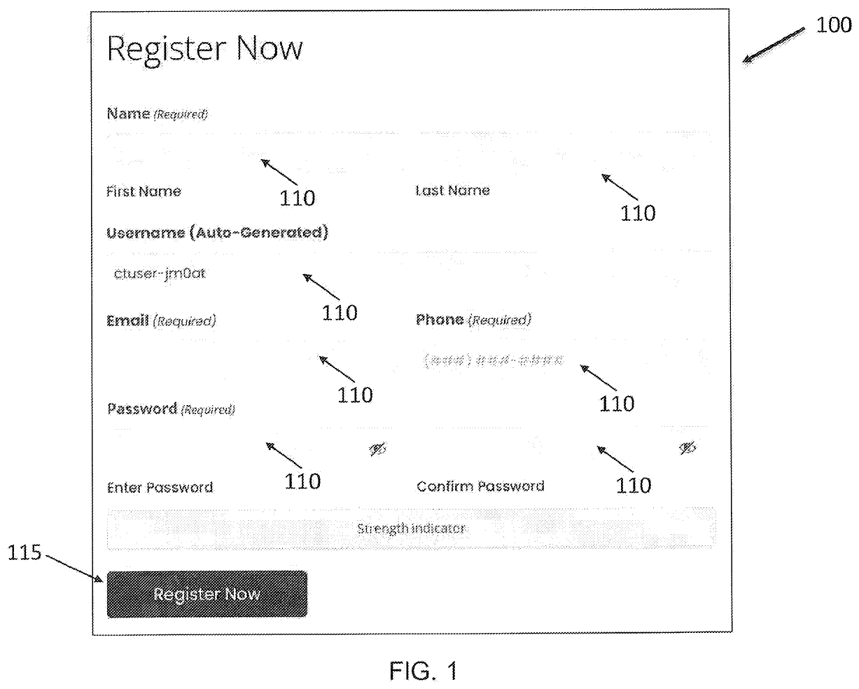

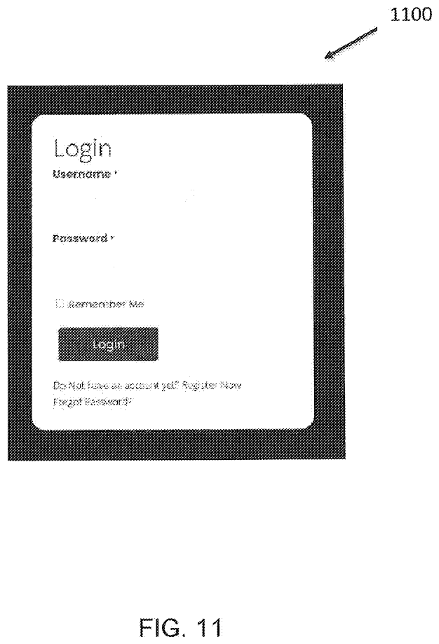

FIG. 1 is a schematic view of a registration screen 100, according to an aspect of the disclosure. In an aspect, a user may use a computing device to access the registration screen 100 for managing trading collectibles. Inputting information into data entry fields 110 of the registration screen 100 allows the user to create an account associated with and dedicated to the user. A user may register with the disclosed system by clicking on the registration icon 115. A login screen 1100 (shown in FIG. 11) allows users to access their account.

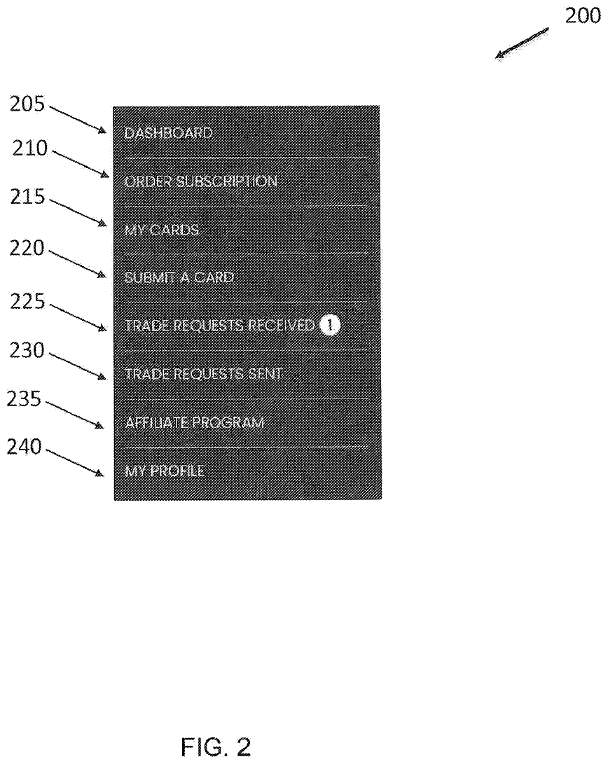

FIG. 2 is a schematic view of a dashboard screen 200, according to an aspect of the disclosure. In an aspect, the user may use the computing device to access dashboard screen 200 of the presently disclosed system for managing trading collectibles. The dashboard screen 200 allows the user to access one or more selection icons (i.e. virtual buttons) 205-240.

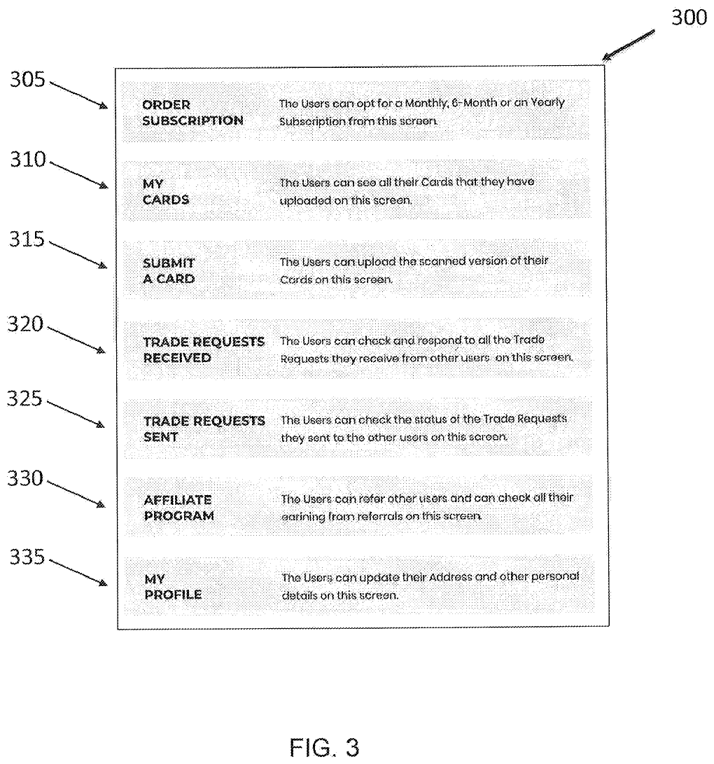

FIG. 3 is another schematic view of a dashboard screen 300, shown in response to detecting a selection of icon 205. In an aspect, a user's computing device displays dashboard screen 300. The dashboard screen 300 allows the user to access one or more selection icons (i.e. virtual buttons) 305-335.

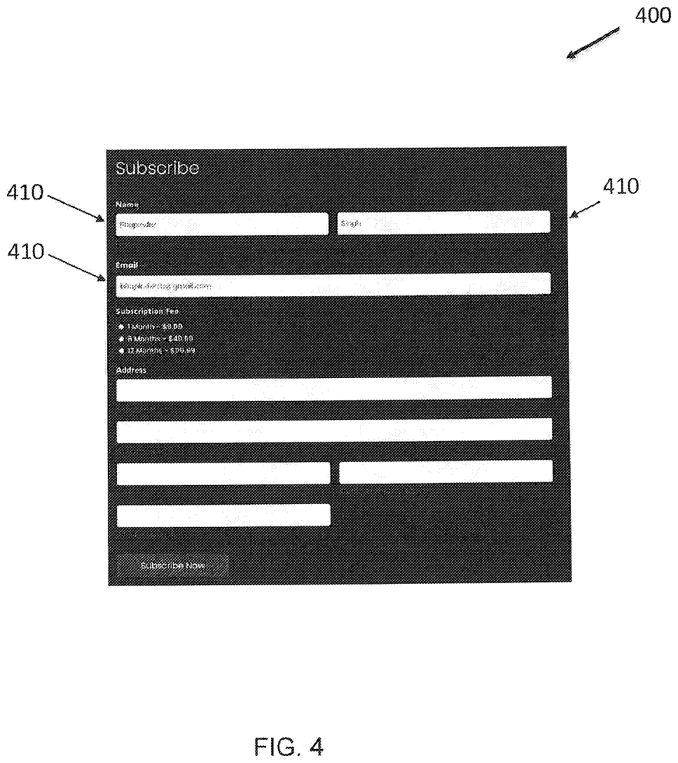

FIG. 4 is a schematic view of a subscribe screen 400, shown in response to detecting selection of icon 210 on dashboard screen 200 or selection icon 305 on dashboard screen 300. In an aspect, the user's computing device displays subscribe screen 400. Inputting information into data entry fields 410 of the subscribe screen 400 allows the user to select a subscription to the presently disclosed system for managing trading collectibles.

In an aspect of the disclosure, different subscription options may be available for a user to select. Different lengths of subscriptions (such as monthly, 6-month or annual) may be available to users. Different access subscriptions may be available, such as an ability to trade collectibles as well as browse collectibles.

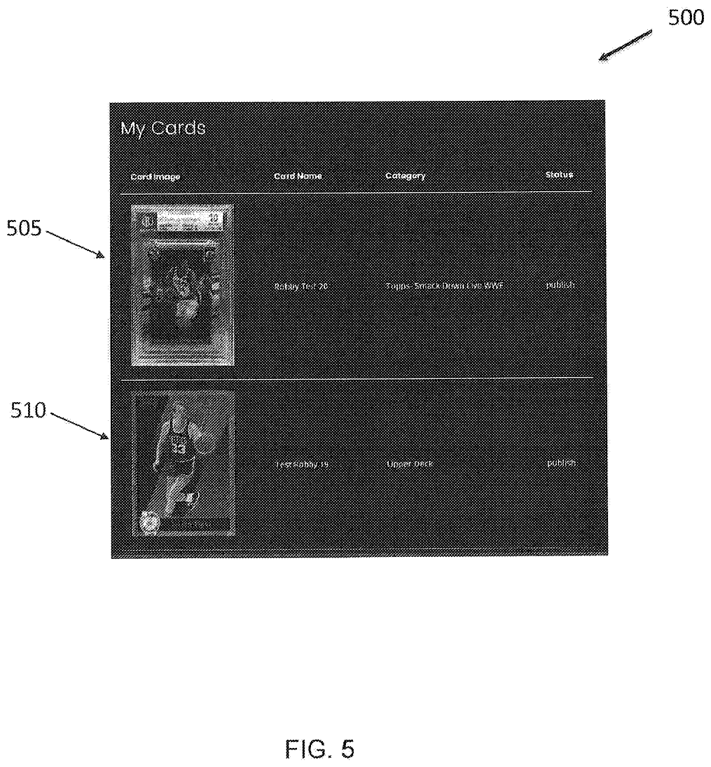

FIG. 5 is a schematic view of a collectibles display screen 500 in an aspect of the disclosure, displayed in response to detecting selection of selection icon 215 on dashboard screen 200 or selection icon 310 on dashboard screen 300. In an aspect, a user's computing device displays collectibles display screen 500. The collectible display screen 500 allows the user to view all collectibles 505, 510 that were uploaded to the user's account. The collectibles 505, 510 may be represented as a selectable icon that allows a user to select a particular collectible 505, 510 for additional detail information. In response to detecting selection of collectible 505 or 510, the user's computing device displays details of the selected collectible 505 or 510. It is understood that more or less than two collectibles may be displayed on collectible display screen 500.

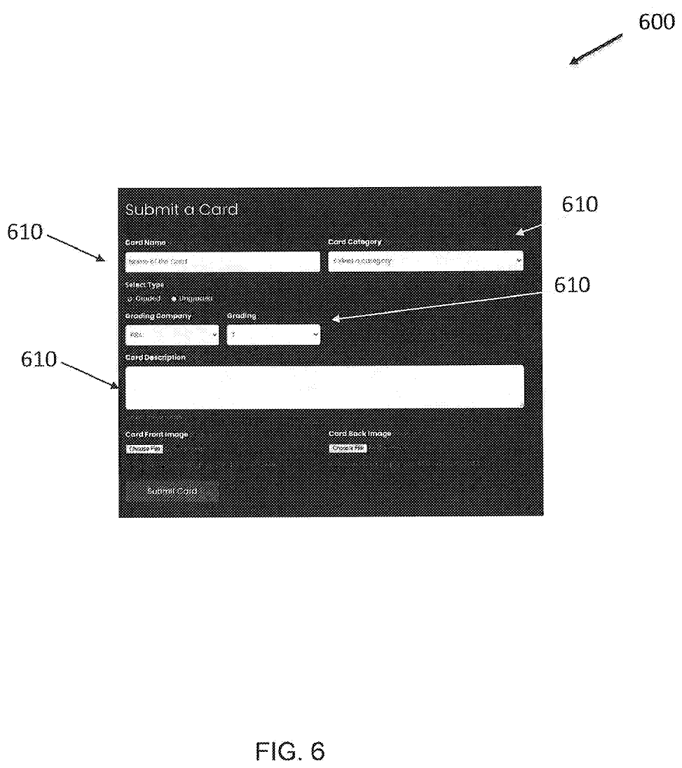

FIG. 6 is a schematic view of a submit collectible screen 600, according to an aspect of the disclosure, in response to detecting selection of selection icon 220 on dashboard screen 200 or selection icon 315 on dashboard screen 300. In an aspect, the user's computing device displays submit collectible screen 600. Inputting information into data entry fields 610 of the submit collectible screen 600 allows the user to input information related to a new collectible to be added to the user's account.

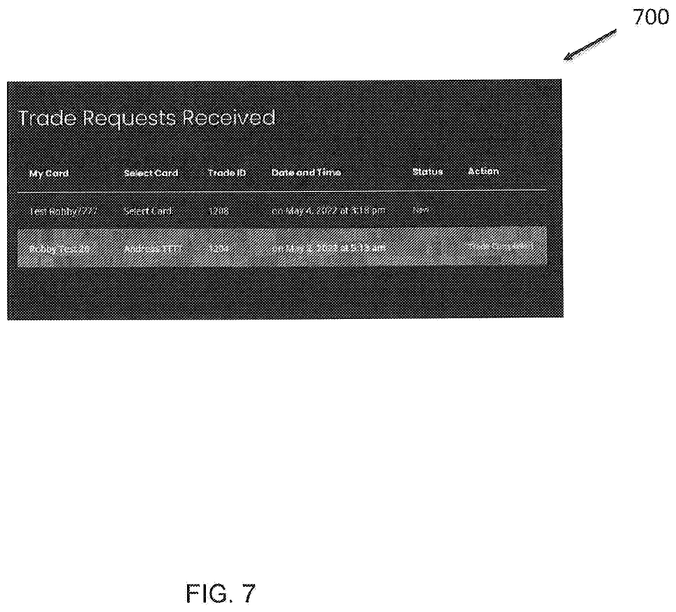

FIG. 7 is a schematic view of a trade requests received screen 700, according to an aspect of the disclosure, displayed in response to detecting selection of selection icon 225 on dashboard screen 200 or selection icon 320 on dashboard screen 300. In an aspect, the user's computing device displays trade requests received screen 700. The trade requests screen 700 allows the user to view any trade requests from other users of the presently disclosed system for managing trading collectibles. According to some aspects, trade requests screen 700 is updated at a predetermined interval of time. According to some aspects, screen trade requests screen 700 is updated every minute.

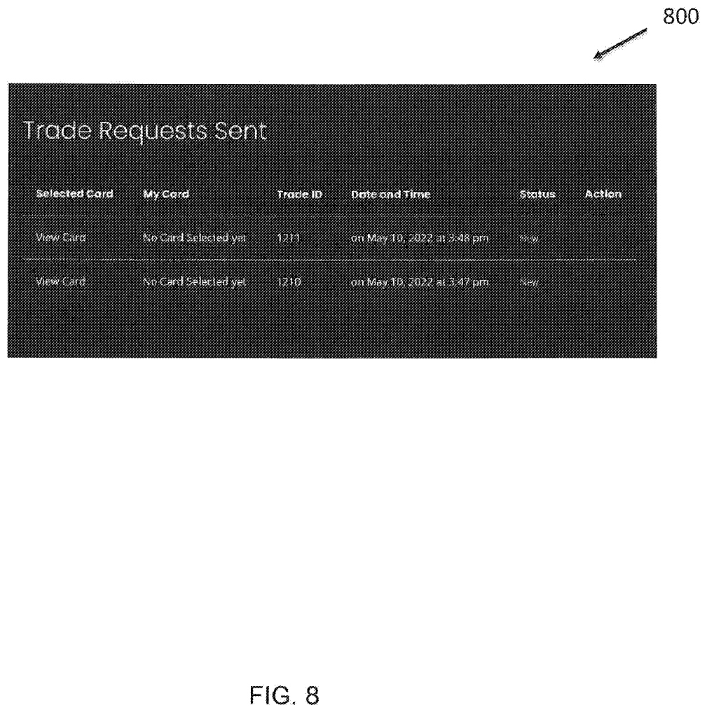

FIG. 8 is a schematic view of a trade requests sent screen 800, according to an aspect of the disclosure, displayed in response to detecting selection of selection icon 230 on dashboard screen 200 or selection icon 325 on dashboard screen 300. In an aspect, the user's computing device displays trade requests sent screen 800. The trade requests sent screen 800 allows the user to view any trade requests that were sent by the user to other users of the presently disclosed system for managing trading collectibles. According to some aspects, trade requests sent screen 800 is updated at a predetermined interval of time. According to some aspects, trade requests sent screen is updated every minute.

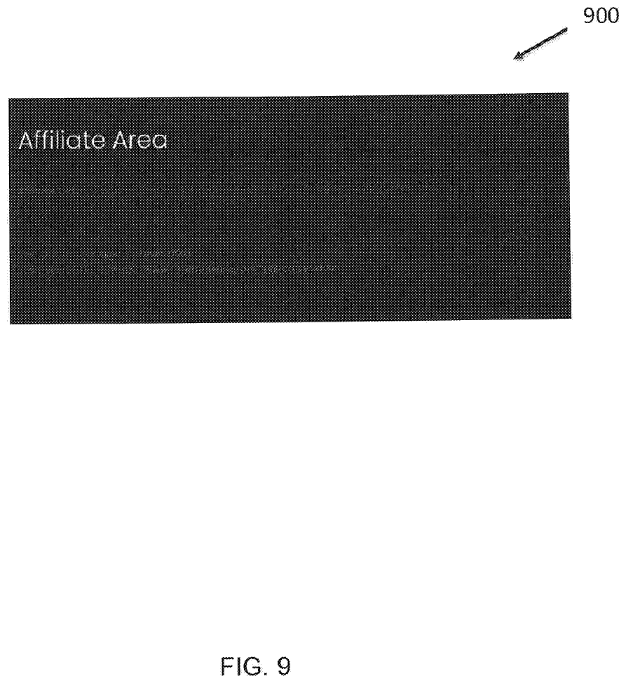

FIG. 9 is a schematic view of an affiliate area screen 900, according to an aspect of the disclosure, displayed in response to detecting selection of selection icon 235 on dashboard screen 200 or selection icon 330 on dashboard screen 300. In an aspect, the user's computing device displays affiliate area screen 900. The affiliate area screen 900 allows the user to refer other people to the presently disclosed system for managing trading collectibles. The affiliate area screen 900 may also allow the user to view how much money they earned from referring other people to the presently disclosed system.

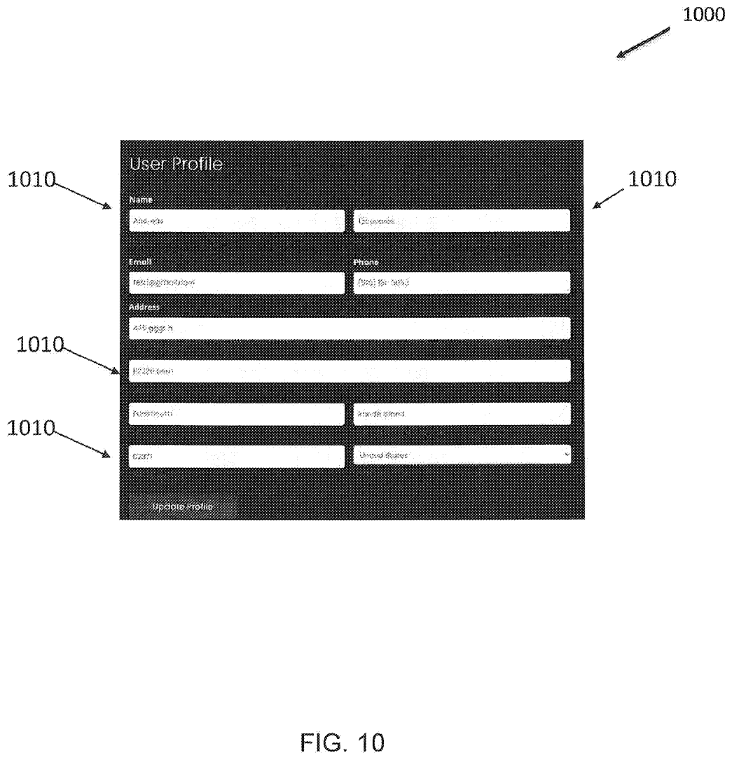

FIG. 10 is a schematic view of a user profile screen 1000, according to an aspect of the disclosure, displayed in response to detecting selection of selection icon 240 on dashboard screen 200 or selection icon 335 on dashboard screen 300. In an aspect, the user's computing device displays the user profile screen 1000. Inputting information into data entry fields 1010 of the user profile screen 1000 allows the user to update their information in their account.

FIG. 11 is a schematic view of a user login screen 1100, according to an aspect of the disclosure. A user may enter login information on the user login screen 1100 once the user creates an account using the registration screen 100.

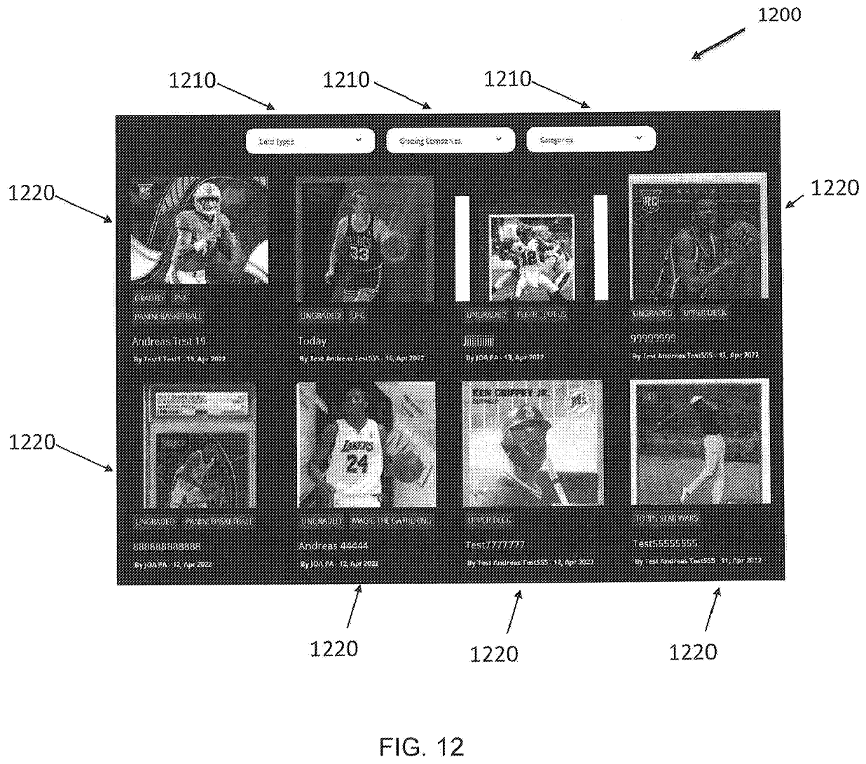

FIG. 12 is a schematic view of a collectible search screen 1200, according to an aspect of the disclosure, of the presently disclosed system for managing trading collectibles. Inputting information into search data fields 1210 of the collectible search screen 1200 allows the user to search for collectibles 1220 available for trade by other users of the presently disclosed system. It is understood that more or fewer collectibles 1220 may be displayed as a result of inputting information into the search data fields 1210.

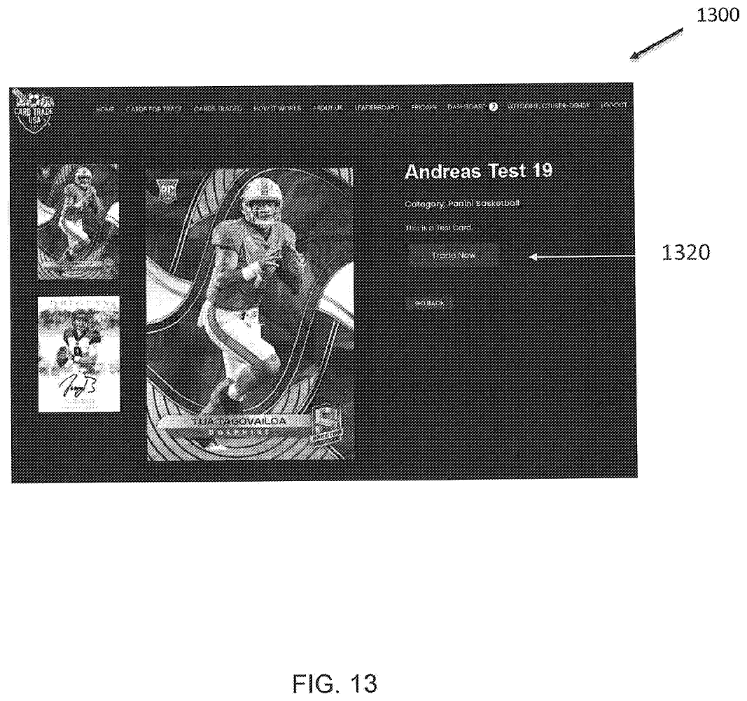

FIG. 13 is a schematic view of a collectible detail screen 1300, according to an aspect of the disclosure, displayed in response to detecting selection of a collectible icon 1220 on the collectible search screen 1200. The collectible detail screen 1300 allows the user to view details corresponding to the selected collectible 1220. The user may desire to trade the displayed collectible 1220 using a trade now icon 1320, according to an aspect of the disclosure.

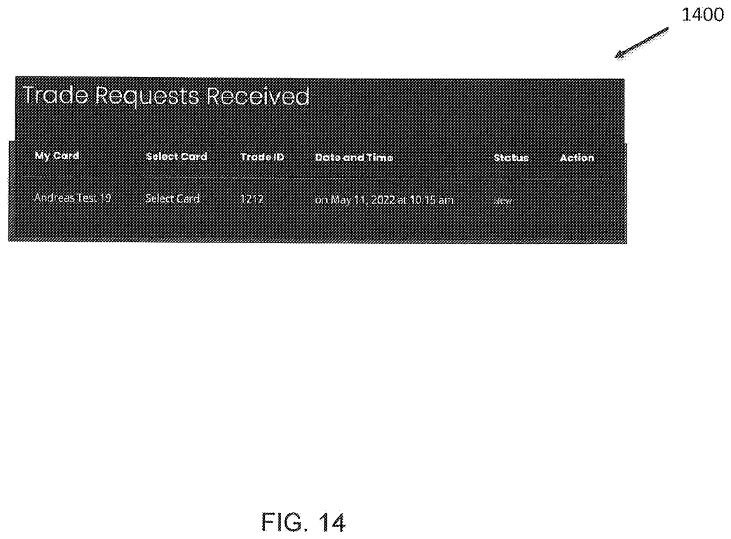

FIG. 14 is a schematic view of a trade requests received screen 1400, according to an aspect of the disclosure, displayed in response to detecting selection of trade now icon 1320 on collectible detail screen 1300. The user's computing device displays screen 1400 and the presently disclosed system will send a trade request to another user of the presently disclosed system who owns the collectible 1220.

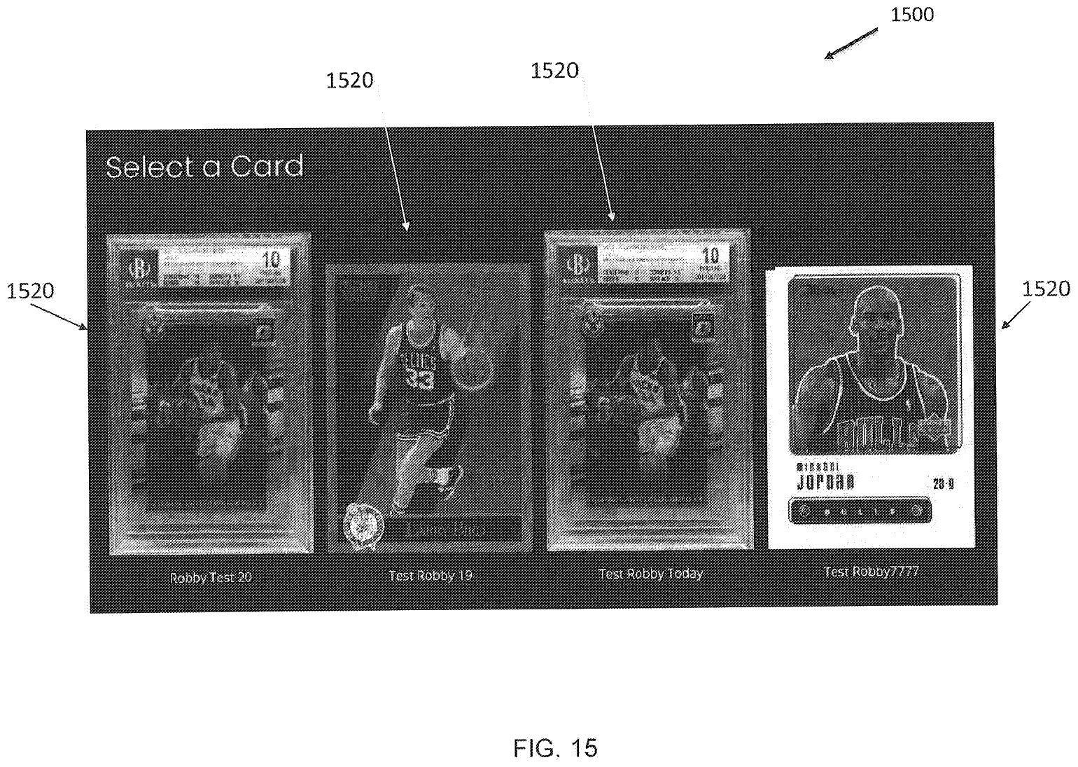

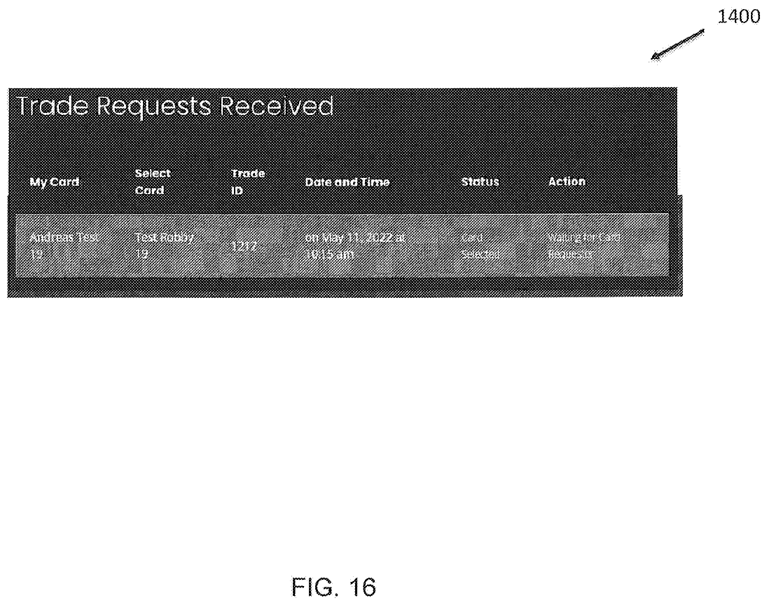

FIG. 15 is a schematic view of a collectible selection screen 1500, according to an aspect of the disclosure. Once the owner of the collectible 1220 receives the trade request, the owner of the collectible 1220 may be directed to collectible selection screen 1500. The collectible selection screen 1500 allows the owner of the collectible 1220 to view collectibles 1520 in the account of the user requesting collectible 1220. Once the owner of the collectible 1220 selects one of the collectibles 1520, the presently disclosed system updates screen 1400 (as shown in FIG. 16).

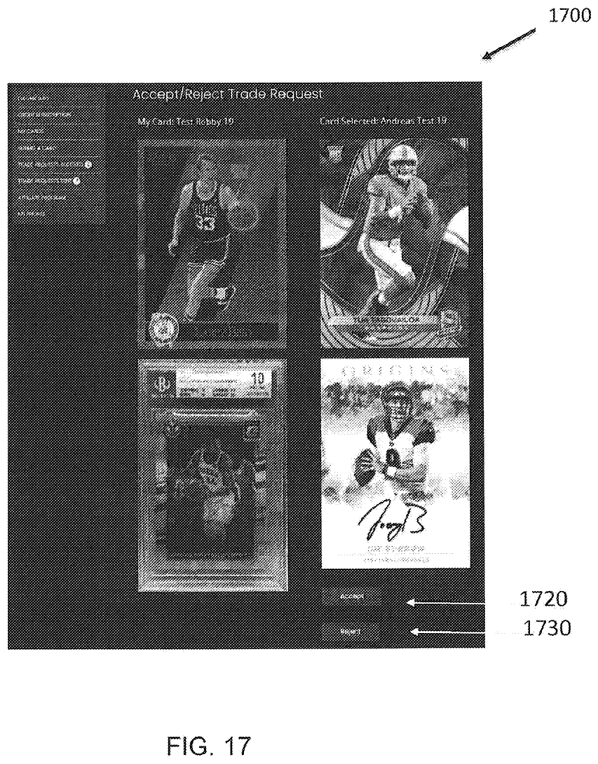

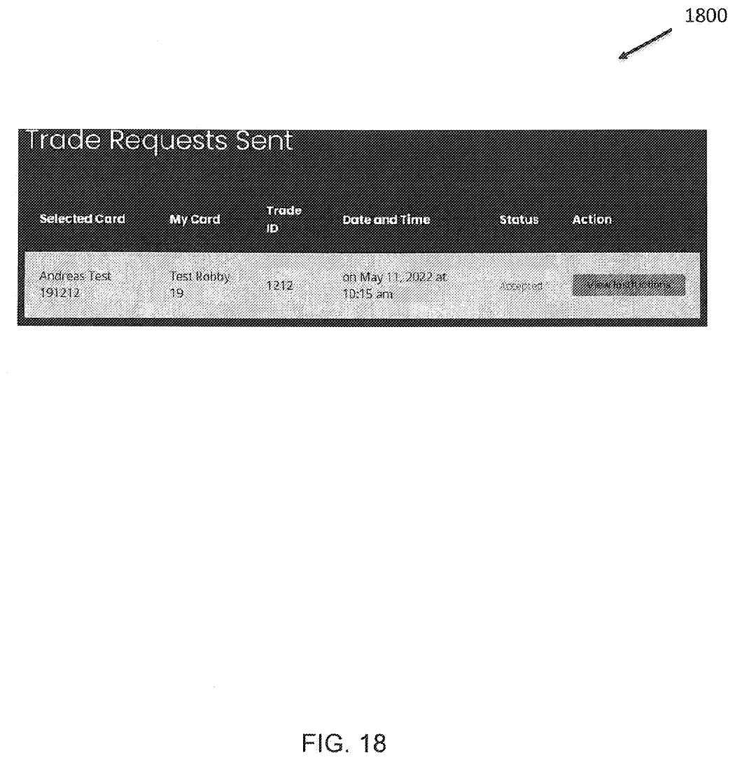

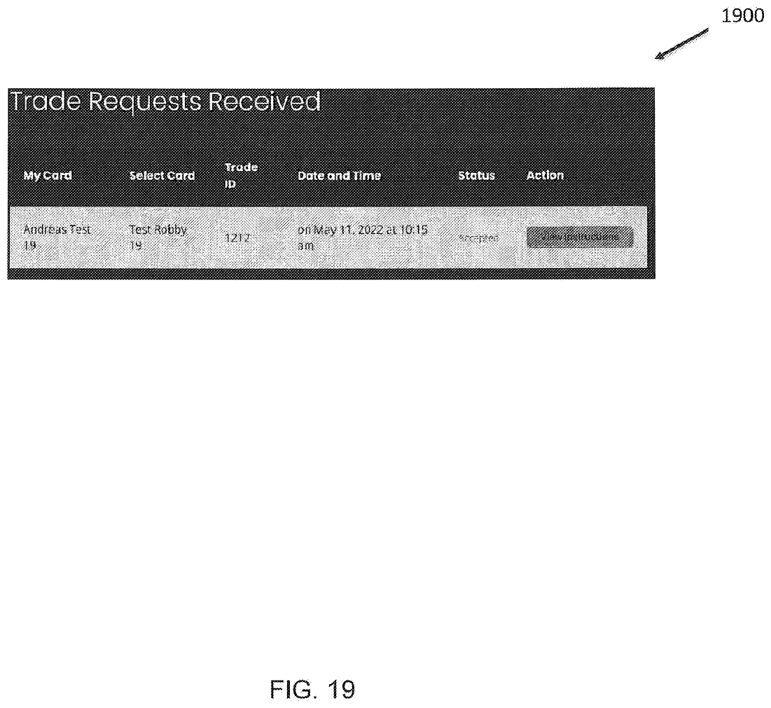

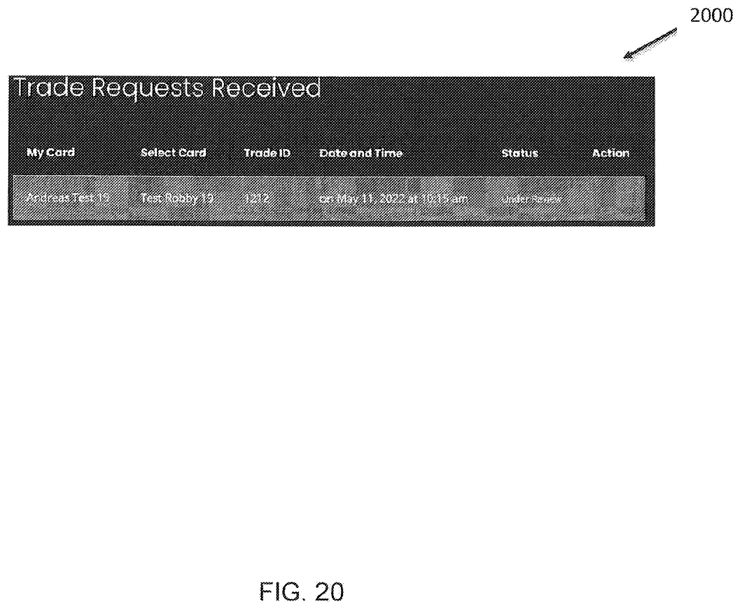

FIG. 16 is a schematic view of a trade requests received screen 1600, according to an aspect of the disclosure. Once the presently disclosed system updates the trade requests received screen 1400, the user who is requesting collectible 1220 may view trade request accept screen 1700 (shown in FIG. 17) and either approve (by selecting accept icon 1720) or decline (by selecting the decline icon 1730) the collectible 1520 that was selected by the owner of the collectible 1220. If the trade request is accepted, the owner of the collectible 1220 and the owner of the collectible 1520 receive confirmations as shown in FIGS. 18-20.

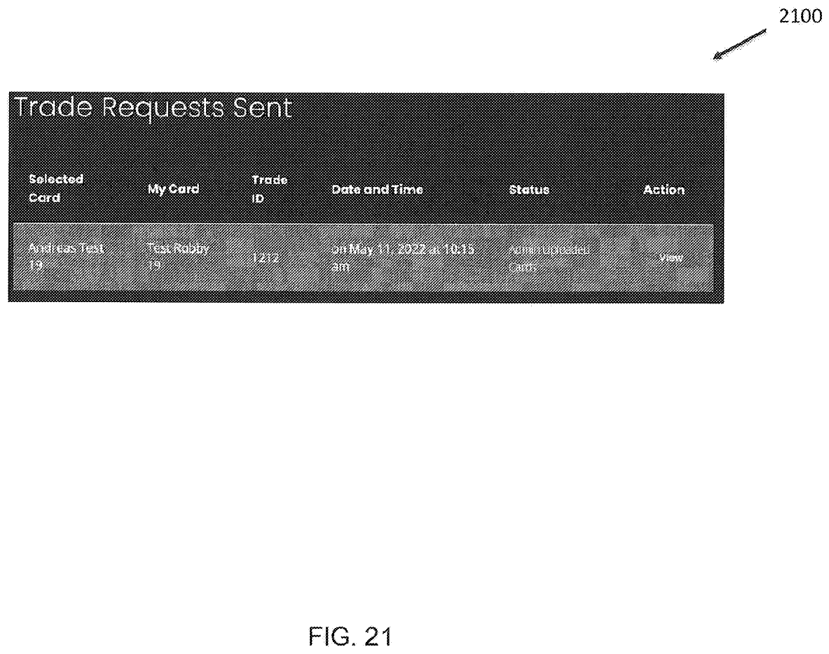

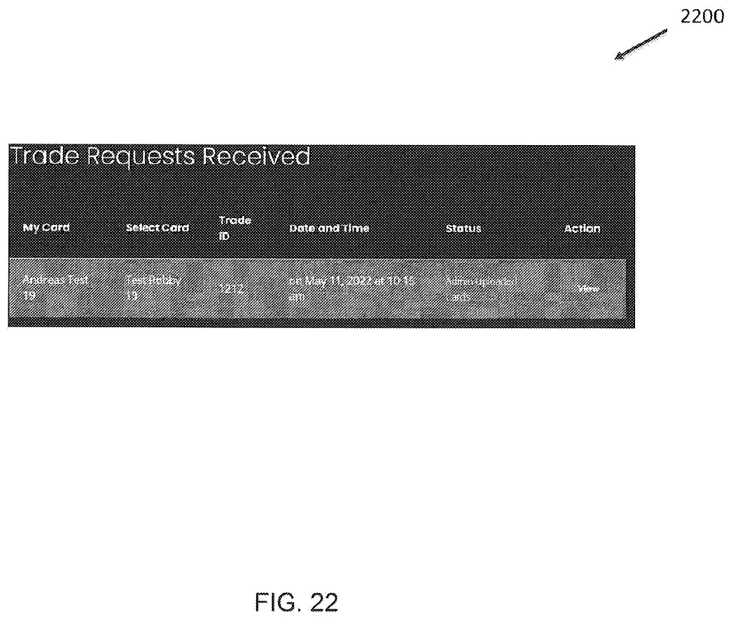

According to some aspects of the disclosure, an administrator of the presently disclosed system may verify collectibles 1220 and 1520 and update screens shown in FIGS. 21-22. The owners of collectibles 1220 and 1520 may be given a final choice of either accept or reject the trade. Once accepted, the administrator will ship collectibles 1220 and 1520 to their respective new owners.

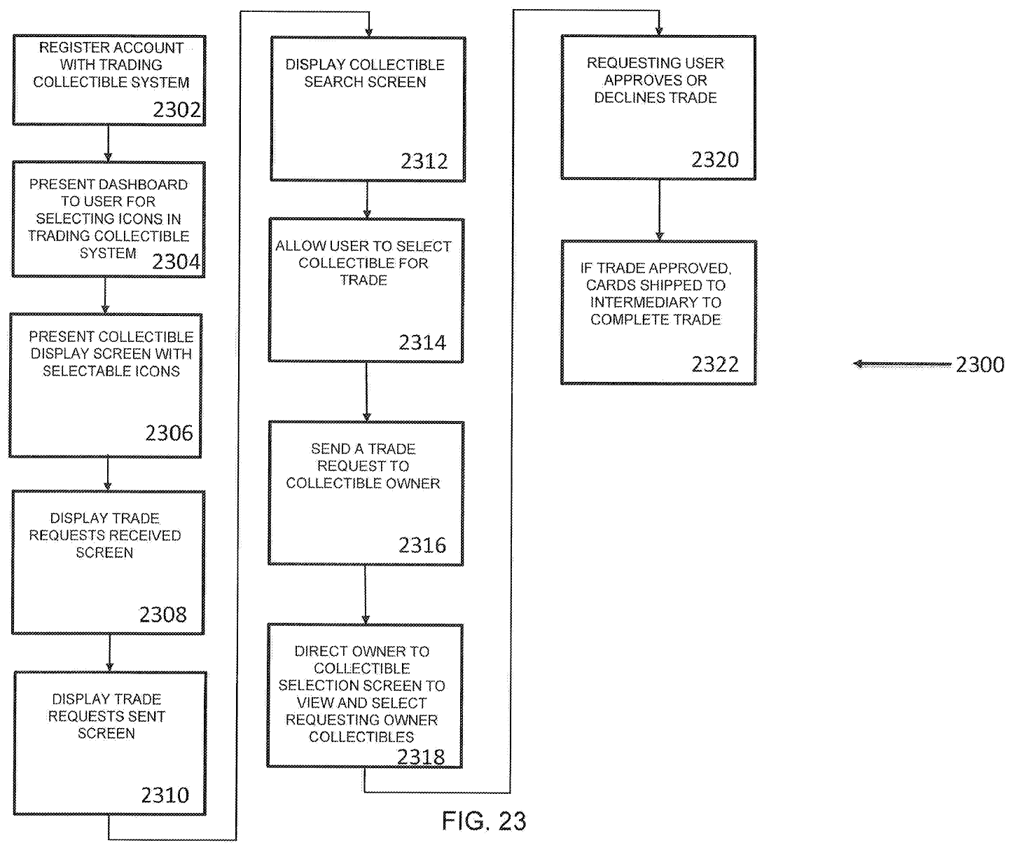

FIG. 23 illustrates acts 2300 taken in a method for managing trading collectibles, according to an aspect of the disclosure. Reference to FIGS. 1-22 is made to illustrate the acts 2300. Control begins at act 2302.

At act 2302, a user registers an account with the system for managing trading collectibles.

At act 2304, the system displays a dashboard for the user to select icons to take actions in the system for managing trading collectibles. In an aspect, the user may use the computing device to access dashboard screen 200 of the presently disclosed system for managing trading collectibles. The dashboard screen 200 allows the user to access one or more selection icons (i.e. virtual buttons) 205-240.

At act 2306, the system presents a collectibles display screen with selectable icons to allow a user to view details of all collectibles the user has uploaded to the system. In an aspect, a user's computing device displays collectibles display screen 500. The collectible display screen 500 allows the user to view all collectibles 505, 510 that were uploaded to the user's account. The collectibles 505, 510 may be represented as a selectable icon that allows a user to select a particular collectible 505, 510 for additional detail information. In response to detecting selection of collectible 505 or 510, the user's computing device displays details of the selected collectible 505 or 510. Inputting information into data entry fields 610 of the submit collectible screen 600 allows the user to input information related to a new collectible to be added to the user's account.

At act 2308, the system displays a trade requests received screen. In an aspect, the user's computing device displays trade requests received screen 700. The trade requests screen 700 allows the user to view any trade requests from other users of the presently disclosed system for managing trading collectibles.

At act 2310, the system displays a trade requests sent screen. In an aspect, the user's computing device displays trade requests sent screen 800. The trade requests sent screen 800 allows the user to view any trade requests that were sent by the user to other users of the presently disclosed system for managing trading collectibles.

At act 2312, the system displays a collectible search screen. Inputting information into search data fields 1210 of the collectible search screen 1200 allows the user to search for collectibles 1220 available for trade by other users of the presently disclosed system.

At act 2314, the system displays allows a user to select a collectible to trade with a trade now icon. A collectible detail screen 1300 allows the user to view details corresponding to the selected collectible 1220. The user may desire to trade the displayed collectible 1220 using a trade now icon 1320, according to an aspect of the disclosure.

At act 2316, the system sends a trade request to the collectible owner. The user's computing device displays screen 1400 and the presently disclosed system will send a trade request to another user of the presently disclosed system who owns the collectible 1220.

At act 2318, once the owner of the collectible 1220 receives the trade request, the owner of the collectible 1220 may be directed to collectible selection screen 1500. The collectible selection screen 1500 allows the owner of the collectible 1220 to view collectibles 1520 in the account of the user requesting collectible 1220. Once the owner of the collectible 1220 selects one of the collectibles 1520, the presently disclosed system updates screen 1400.

At 2320, the requesting user may approve or decline the collectible trade proposed by the receiving user. Once the presently disclosed system updates the trade requests received screen 1400, the user who is requesting collectible 1220 may view trade request accept screen 1700 (shown in FIG. 17) and either approve (by selecting accept icon 1720) or decline (by selecting the decline icon 1730) the collectible 1520 that was selected by the owner of the collectible 1220. If the trade request is accepted, the owner of the collectible 1220 and the owner of the collectible 1520 receive confirmations as shown in FIGS. 18-20.

According to some aspects of the disclosure, an administrator of the presently disclosed system may verify collectibles 1220 and 1520 and update screens shown in FIGS. 21-22. The owners of collectibles 1220 and 1520 may be given a final choice of either accept or reject the trade.

At act 2322, if the trade is approved, both users will have to send their collectibles to an intermediary administrator, such as a central company or application server administering the online application. In an aspect, the intermediary administrator receives the items and uploads the images of the collectibles. Both users will receive a notification on their respective accounts and they will have to approve that these are the items they have agreed to trade. Once both users agree, the intermediary administrator will ship the items to the users. No one on the trading application knows with whom they are trading. If one or both users don't agree on the item, the company will not approve the trade and the items will be sent back to the owners. once the collectible trade is accepted, the administrator will ship collectibles 1220 and 1520 to their respective new owners.

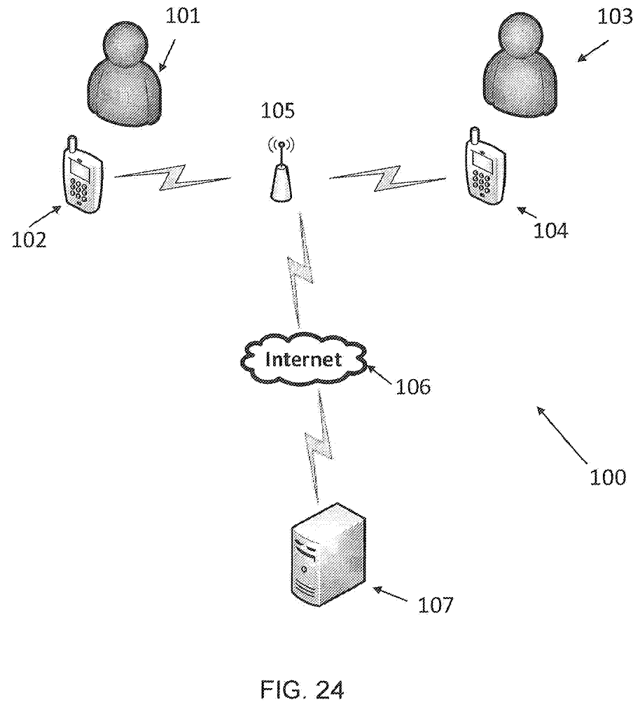

FIG. 24 illustrates an example communications network 100 employed by users 101, 103 that supports the disclosed system for managing trading collectibles. In an aspect of the disclosure, the users 101, 103 may be individual traders owning or seeking to own trading collectibles.

The communications network 100 may include a first user equipment (UE) 102 and a second UE 104. There may be multiple UEs connected to the communications network 100 and the UEs may be computing devices such as smart phones, laptops, tablet devices, smart watches, desktop computers, or other equipment that can connect in a wired or wireless manner. The communications network 100 may include a wired or wireless access point (AP) 105. The AP 105 may be a terrestrial wireless network such as a cellular communications network, WiFi network or other wireless connectivity systems. The AP 105 may be a satellite that supports ground-based communications. Examples of a wired communications network includes Ethernet, fiber, cable or other wired communications connectivity systems.

In an aspect of the disclosure, the AP 105 may connect to the Internet 106, as understood by one of skill in the art. The Internet 106 may include various routers and hubs (not shown).

In an aspect of the disclosure, the Internet 106 may connect UEs 102, 104 to a server 107. The server 10) may contain processors, input units, memory, and output display units (not shown). The server 107 may support the functions of the disclosed system for managing trading collectibles. The server 107 may be multiple servers and the method of the disclosed system for managing trading collectibles may be implemented across multiple servers, the UEs 102, 104 or other processing devices as needed. The server 107 may also include a cloud-based collection of one or more servers distributed in different locations and/or or making use of cloud-based applications to implement the disclosed system for managing trading collectibles.

In an aspect, the server 107 may be located in local proximity to the UEs 102, 104 such that the UEs 102, 104 do not access the Internet 106 to make use of the disclosed system for managing trading collectibles.

Blocks of the flowchart 2300 support combinations of means for performing the specified functions and combinations of operations for performing the specified functions of an aspect. It will also be understood that one or more blocks of the flowchart 2300 and combinations of blocks in the flowchart 2300, can be implemented by special purpose hardware-based computer systems which perform the specified functions, or combinations of special purpose hardware and computer instructions. Also, more, fewer or different steps may be provided. Any of these modifications do not deviate from the scope of the disclosure and the novel inventive features presented herein.

Alternatively, the system may comprise other means for performing each of the operations described above. In this regard, according to an example aspect, examples of means for performing operations may comprise, for example, a computer processor and/or a device or circuit for executing instructions or executing an algorithm for processing information as described above. Storage in the form of databases located in local, remote or cloud storage locations may be used in conjunction with the disclosed system and method for words, word levels, graphics, audio-visual interaction and other types of data or information that may be used with the disclosed system and method. Computer I/O devices may also be used, such a mouse, stylus, touch pads, touch screens, keyboards, speakers, microphones, headsets or other I/O devices known to one of skill in the art to be used with the disclosed system and method.

It will be understood that each block of the flowcharts and combination of blocks in the flowcharts may be implemented by various means, such as hardware, firmware, processor, circuitry, and/or other communication devices associated with execution of software including one or more computer method and system instructions. For example, one or more of the procedures described above may be embodied by computer method and system instructions. In this regard, the computer method and system instructions which embody the procedures described above may be stored by a memory device of an apparatus employing an aspect of the present disclosure and executed by the processing circuitry. As will be appreciated, any such computer method and system instructions may be loaded onto a computer or other programmable apparatus (for example, hardware) to produce a machine, such that the resulting computer or other programmable apparatus implements the functions specified in the flowchart blocks. These computer method and system instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer method and system instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

A “computer-readable medium,” “machine-readable medium,” “propagated-signal” medium, and/or “signal-bearing medium” may comprise any means that contains, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM” (electronic), a Read-Only Memory “ROM” (electronic), an Erasable Programmable Read-Only Memory (EPROM or Flash memory) (electronic), or an optical fiber (optical). A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

Many modifications and other aspects of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific aspects disclosed and that modifications and other aspects are intended to be included within the scope of the appended claims. Furthermore, in some aspects, additional optional operations may be included. Modifications, additions, or amplifications to the operations above may be performed in any order and in any combination.

Moreover, although the foregoing descriptions and the associated drawings describe example aspects in the context of certain example combinations of elements and/or functions, it should be appreciated that different combinations of elements and/or functions may be provided by alternative aspects without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A computer-implemented method to manage trading of collectibles using an online application, the method comprising:
allowing a user to register with the online application for trading the collectibles;
presenting a dashboard screen interface to allows the user to access one or more selection icons associated with trading the collectibles;
allowing the user to upload one or more user owned collectible collectibles to the online application;
displaying a trade request screen interface to allow the user to view a received trade request from a requesting user on the online application;
displaying a trade request sent screen interface to allow the user to view a sent trade request sent by the user to a receiving user on the online application;
upon receiving a trade request, directing the user to a collectible selection screen interface to allow the user to view collectibles owned by the requesting user;
allowing selection, by the user, of one or more of the collectibles owned by the requesting user for a trade between the user and the requesting user;
allowing approval of the trade between the user and the requesting user or decline of the trade between the user and the requesting user; and
responsive to the approval of the trade between the user and the requesting user, completing the trade between the user and the requesting user.

2. The method of claim 1, further comprising providing a collectible search screen interface to allow the user to search for desired collectibles owned by other users on the online application.

3. The method of claim 1, further comprising providing a subscription screen interface to allow the user to select a subscription for services on the online application.

4. The method of claim 1, further comprising presenting selectable icons associated with the collectibles, where, upon selecting the selectable icons, collectible details are presented.

5. The method of claim 1, where completing the trade between the user and the requesting user comprises verifying the trade between the user and the requesting user; and providing shipping of collectibles involved in the trade between the user and the requesting user.

6. The method of claim 1, further comprising presenting an affiliate area screen interface to allow the user to refer other users to join the online application.

7. A system for managing trading of collectibles using an online application, the system comprising:
at least one memory configured to store computer executable instructions; and at least one processor configured to execute the computer executable instructions to:
allow a user to register with the online application for trading the collectibles;
present a dashboard screen interface to allows the user to access one or more selection icons associated with trading the collectibles;
allow the user to upload one or more user owned collectibles to the online application;
display a trade request screen interface to allow the user to view a received trade request from a requesting user on the online application;
display a trade request sent screen interface to allow the user to view a sent trade request sent by the user to a receiving user on the online application;
upon receiving a trade request, direct the user to a collectible selection screen interface to allow the user to view collectibles owned by the requesting user;
allow selection, by the user, of one or more of the collectible collectibles owned by the requesting user for a trade between the user and the requesting user;
allow approval of the trade between the user and the requesting user or decline of the trade between the user and the requesting user; and
responsive to the approval of the trade between the user and the requesting user, completing the trade between the user and the requesting user.

8. The system of claim 7, further comprising computer executable instructions to provide a collectible search screen interface to allow the user to search for desired collectibles owned by other users on the online application.

9. The system of claim 7, further comprising computer executable instructions to provide a subscription screen interface to allow the user to select a subscription for services on the online application.

10. The system of claim 7, further comprising computer executable instructions to present selectable icons associated with the collectibles, where, upon selecting the selectable icons, collectible details are presented.

11. The system of claim 7, where the computer executable instructions to completing the trade between the user and the requesting user comprise computer executable instructions to; verify the trade between the user and the requesting user; and provide shipping of collectibles involved in the trade between the user and the requesting user.

12. The method of claim 1, further comprising computer executable instructions to present an affiliate area screen interface to allow the user to refer other users to join the online application.

13. A computer program product comprising a non-transitory computer readable medium having stored thereon computer executable instructions, which when executed by one or more processors, cause the one or more processors to manage trading of collectibles using an online application, the computer executable instructions comprising:
allowing a user to register with the online application for trading the collectibles;
presenting a dashboard screen interface to allows the user to access one or more selection icons associated with trading the collectibles;
allowing the user to upload one or more user owned collectibles to the online application;
displaying a trade request screen interface to allow the user to view a received trade request from a requesting user on the online application;
displaying a trade request sent screen interface to allow the user to view a sent trade request sent by the user to a receiving user on the online application;
upon receiving a trade request, directing the user to a collectible selection screen interface to allow the user to view one or more collectibles owned by the requesting user;
allowing selection, by the user, of one or more of the collectibles owned by the requesting user for a trade between the user and the requesting user;
allowing approval of the trade between the user and the requesting user or decline of the trade between the user and the requesting user; and
responsive to the approval of the trade between the user and the requesting user, completing the trade between the user and the requesting user.

14. The computer program product of claim 13, further comprising computer executable instructions for providing a collectible search screen interface to allow the user to search for desired collectibles owned by other users on the online application.

15. The computer program product of claim 13, further comprising computer executable instructions for providing a subscription screen interface to allow the user to select a subscription for services on the online application.

16. The computer program product of claim 13, further comprising computer executable instructions for presenting selectable icons associated with the collectibles, where, upon selecting the selectable icons, collectible details are presented.

17. The computer program product of claim 13, where the computer executable instructions for completing the trade between the user and the requesting user comprises verifying the trade between the user and the requesting user; and providing shipping of collectibles involved in the trade between the user and the requesting user.

18. The computer program product of claim 13, further comprising computer executable instructions for presenting an affiliate area screen interface to allow the user to refer other users to join the online application.

19. The computer program product of claim 13, where the computer executable instructions for the allowing selection, by the user, of one or more of the collectibles owned by the requesting user for a trade between the user and the requesting user comprise computer executable instructions for displaying a trade selection icon.

20. The computer program product of claim 13, further comprising computer executable instructions for sending a trade request from the user.
